(19) United States
(12) Patent Application Publication
(10) Pub. No.: US 2024/0364155 A1
(43) Pub. Date: Oct. 31, 2024

(54) MODULAR PERMANENT MAGNET ROTOR PRODUCED BY INJECTION MOLDING AND MOTOR COMPRISING THE SAME

(71) Applicant: Hubei Queen-Ocean Electrical Appliance Manufacture Co., Ltd., Xiaogan (CN)

(72) Inventors: Yonghua WU, Xiaogan (CN); Jingxin CHEN, Xiaogan (CN); Mingpan PAN, Xiaogan (CN)

(21) Appl. No.: 18/767,933

(22) Filed: Jul. 9, 2024

Related U.S. Application Data
(63) Continuation-in-part of application No. PCT/CN2023/113416, filed on Aug. 16, 2023.

(30) Foreign Application Priority Data
Feb. 8, 2023 (CN) 202320197727.8

(51) Int. Cl. H02K 1/276; H02K 1/02

(52) U.S. Cl. CPC H02K 1/276; H02K 1/02; H02K 2213/03

(57) ABSTRACT

A modular permanent magnet rotor produced by injection molding, including: an inner core including a central axial hole; a plurality of permanent magnets; a plastic body; and a plurality of outer iron cores. A plurality of radial grooves are formed between every two adjacent outer iron cores, and the plurality of permanent magnets are disposed in the plurality of radial grooves, respectively. The inner core includes a circumferential outer wall including a plurality of dovetail grooves; each of the plurality of outer iron cores includes an inner end includes a dovetail protrusion. The plurality of outer iron cores are disposed around the circumferential outer wall of the inner core, and dovetail protrusions are embedded in the plurality of dovetail grooves, respectively. A gap is formed between the front end of each of the dovetail protrusions and the bottom end of each of the plurality of dovetail grooves.

### CROSS-REFERENCE TO RELATED APPLICATIONS

This application is a continuation-in-part of International Patent Application No. PCT/CN2023/113416 with an international filing date of Aug. 16, 2023, designating the United States, now pending, further claims foreign priority benefits to Chinese Patent Application No. 202320197727.8 filed Feb. 8, 2023. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to a modular permanent magnet rotor produced by injection molding and a motor comprising the same.

A modular scheme for producing a permanent magnet injection molded rotor can reduce material costs and prevent magnetic leakage, greatly improving the magnetic performance of the rotor. Conventional modular rotors include an inner rotor core and an outer rotor core, and the two elements are fixed by plastic injection. However, due to the characteristics of plastics, there is a significant variation in the size of the injection plastic material in high-temperature and high-humidity environments. Thus, the inner rotor core and the outer rotor core are not fixed relative to each other. The size of the rotor will change with the changes of the plastic parts. Occasionally, the motor rotor is stuck due to edge rubbing.

### SUMMARY

The disclosure provides a modular permanent magnet rotor produced by injection molding, comprising: an inner core comprising a central axial hole; a plurality of permanent magnets; a plastic body; and a plurality of outer iron cores. A plurality of radial grooves are formed between every two adjacent outer iron cores, and the plurality of permanent magnets are correspondingly disposed in the plurality of radial grooves, respectively; the inner core comprises a circumferential outer wall comprising a plurality of dovetail grooves spaced apart; each of the plurality of outer iron cores comprises an inner end comprising a dovetail protrusion; the plurality of outer iron cores are disposed around the circumferential outer wall of the inner core, and dovetail protrusions are embedded in the plurality of dovetail grooves, respectively; a gap is formed between a front end of each of the dovetail protrusions and a bottom end of each of the plurality of dovetail grooves; the plastic body integrates the inner core, the plurality of outer iron cores, and the plurality of permanent magnets into a whole body, and a part of the plastic body is embedded in the gap.

In a class of this embodiment, the inner core is a single non-magnetic nonferrous metal block.

In a class of this embodiment, a material for the inner core is aluminum alloy, or austenitic stainless steel, or copper material.

In a class of this embodiment, a distance between the front end of each of the dovetail protrusions and the bottom end of each of the plurality of dovetail grooves is L1; a distance between an outer circumferential wall of the plastic body and an outer circumferential wall of the plurality of outer iron cores is L2; and L1≥2.5×L2.

In a class of this embodiment, a distance between the outer circumferential wall of the plurality of outer iron cores and a center of the central axial hole is C, and C=r×cos(10°−15°), wherein r represents a radius of the rotor.

In a class of this embodiment, an axial length D1 of the plurality of permanent magnets is larger than an axial length D2 of the plurality of outer iron cores.

In a class of this embodiment, the dovetail protrusion comprises a neck connected to the front end, and the neck is narrower than the front end; and the plurality of dovetail grooves comprises a narrow opening and a wide inside, and the dovetail protrusion is embedded in the dovetail groove via the narrow opening.

In a class of this embodiment, each of the plurality of outer iron cores comprises a through hole; during injection molding, a part of the plastic body is embedded in the through hole.

In a class of this embodiment, each of the plurality of outer iron cores further comprises a location hole.

The disclosure further provides a motor, comprising a rotation shaft, the abovementioned permanent magnet injection molded rotor, a stator assembly, and a housing.

The following advantages are associated with the permanent magnet injection molded rotor of the disclosure. The inner core comprises a circumferential outer wall comprising a plurality of dovetail grooves spaced apart; each of the plurality of outer iron cores comprises an inner end comprising a dovetail protrusion; the plurality of outer iron cores are disposed around the circumferential outer wall of the inner core, and dovetail protrusions are embedded in the plurality of dovetail grooves, respectively; a gap is formed between a front end of each of the dovetail protrusions and a bottom end of each of the plurality of dovetail grooves; the plastic body integrates the inner core, the plurality of outer iron cores, and the plurality of permanent magnets into a whole body, and a part of the plastic body is embedded in the gap. The dovetail grooves and dovetail protrusions are matched to fix the inner and outer iron cores, avoiding the relative position movement between the inner and outer iron cores due to the size changes of injection molding material in high temperature and humidity environments. The injection pressure ensures the bonding force between the inner and outer iron cores, ensuring the outer diameter size of the rotor, and effectively preventing noise and edge rubbing of the motor rotor.

### BRIEF DESCRIPTION OF THE DRAWINGS

FIG. 1 is a schematic diagram of a modular permanent magnet rotor produced by injection molding in accordance with one embodiment of the disclosure;

FIG. 2 is an exploded view of a modular permanent magnet rotor produced by injection molding in accordance with one embodiment of the disclosure;

FIG. 3 is a side view of a modular permanent magnet rotor produced by injection molding in accordance with one embodiment of the disclosure;

FIG. 4 is a sectional view taken from line A-A in FIG. 3;

FIG. 5 is a local enlarged view of part B in FIG. 4;

FIG. 6 is a top view of a modular permanent magnet rotor produced by injection molding in accordance with one embodiment of the disclosure;

FIG. 7 is an exploded view of permanent magnets and outer iron cores in accordance with one embodiment of the disclosure;

FIG. 8 is an exploded view of an inner core and outer iron cores in accordance with one embodiment of the disclosure; and

FIG. 9 shows an axial length D1 of a plurality of permanent magnets and an axial length D2 of a plurality of outer iron cores.

### DETAILED DESCRIPTION

To further illustrate the disclosure, embodiments detailing a modular permanent magnet rotor produced by injection molding are described below. It should be noted that the following embodiments are intended to describe and not to limit the disclosure.

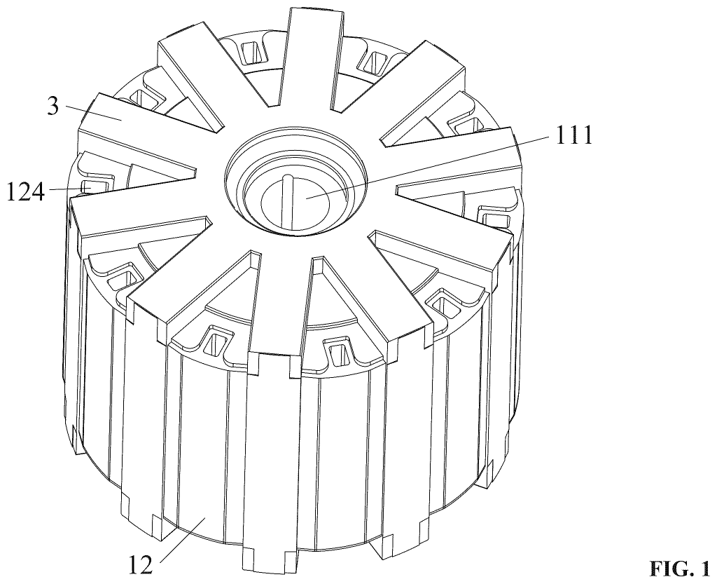

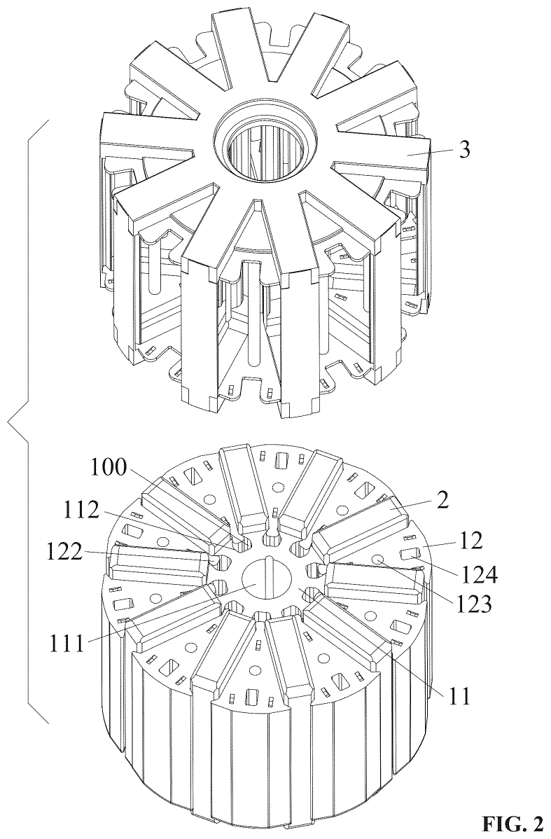

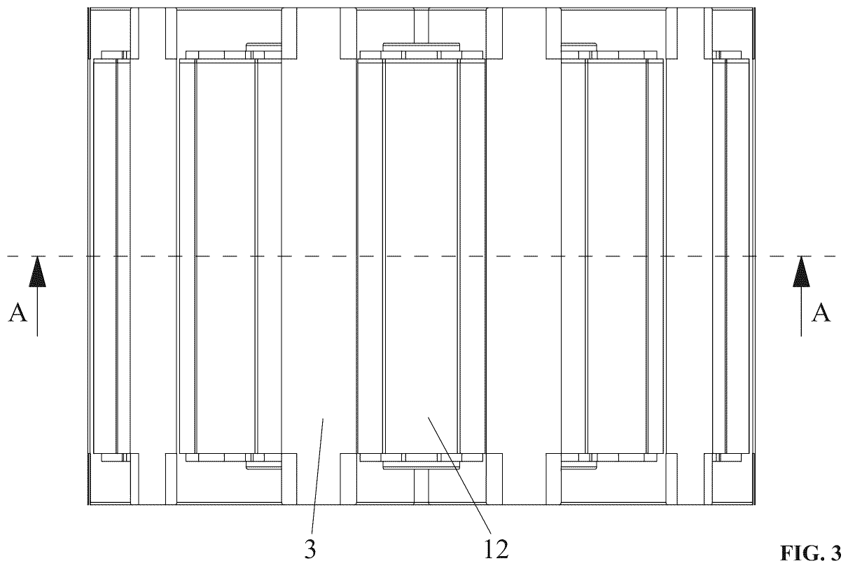

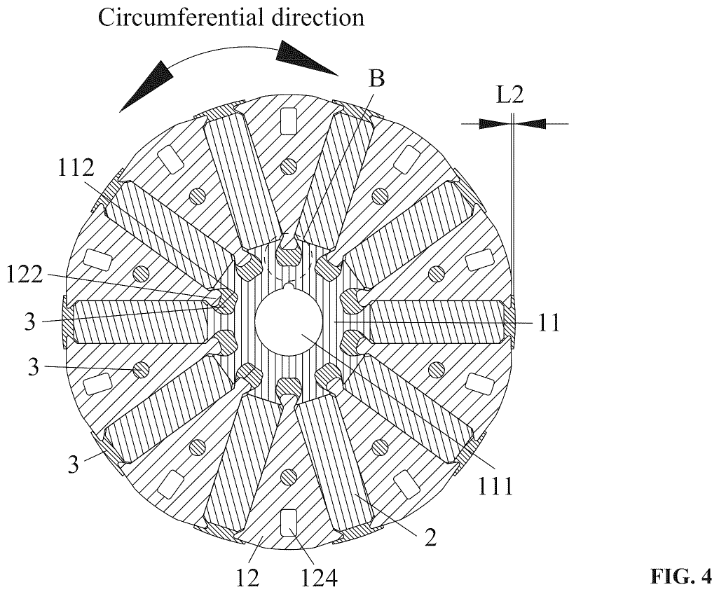

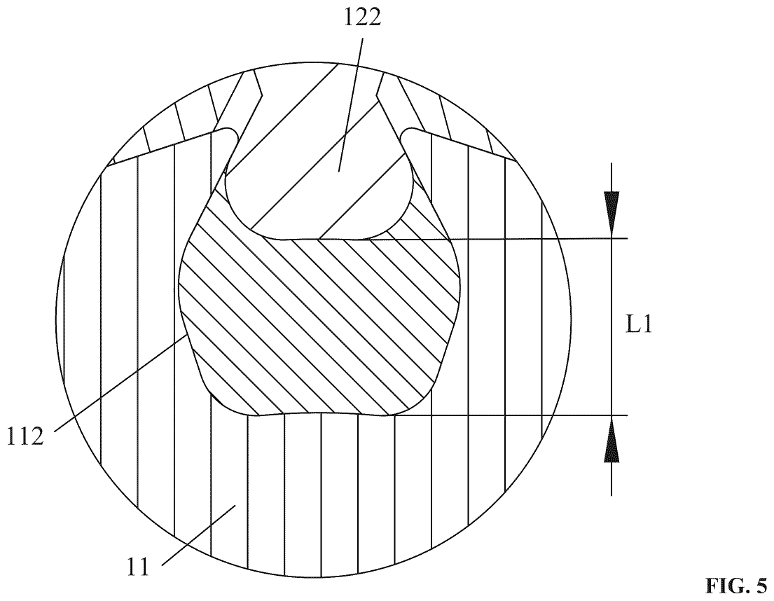

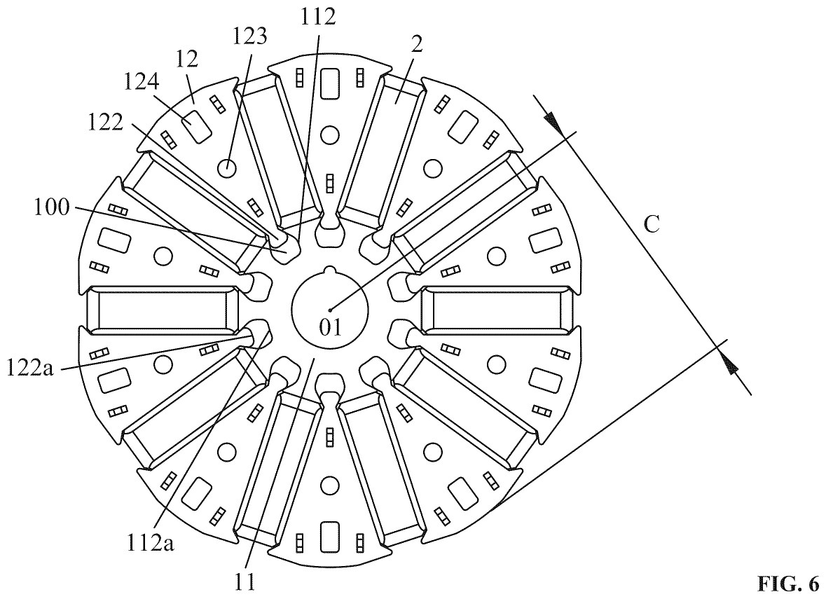

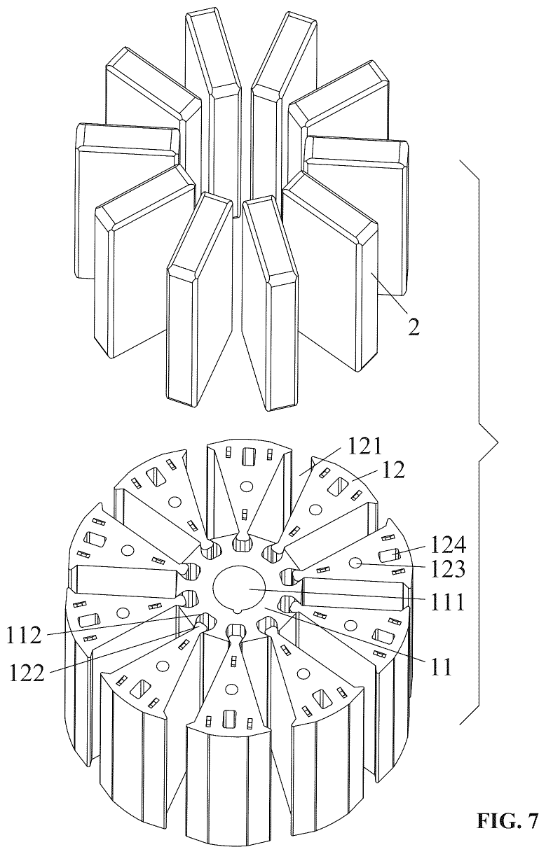

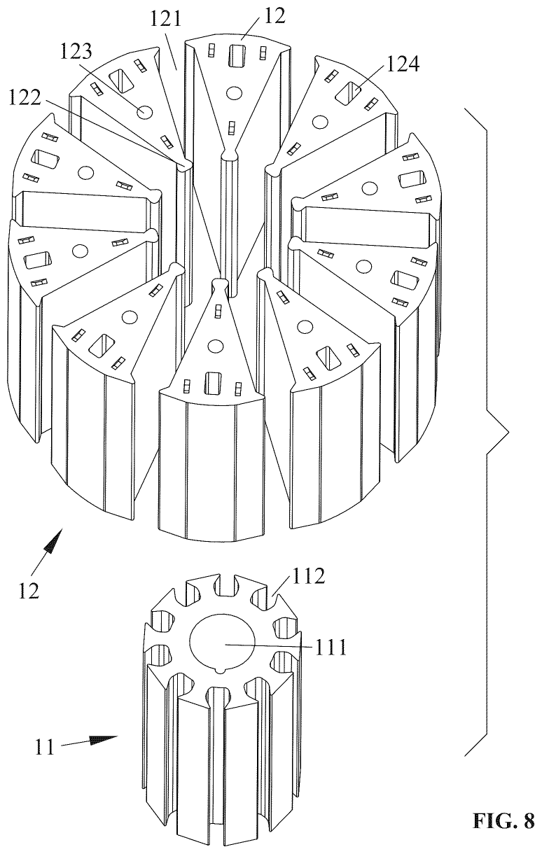

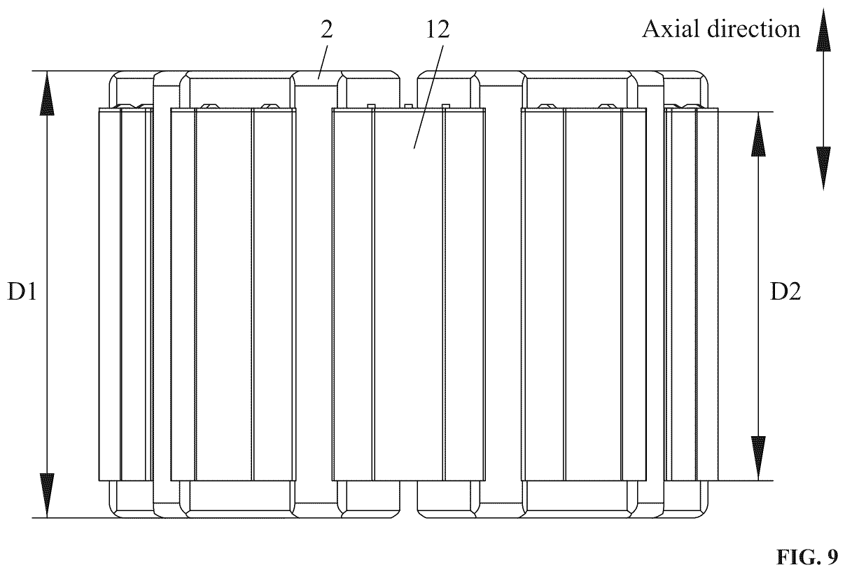

As shown in FIGS. 1-9, the disclosure provides a modular permanent magnet rotor produced by injection molding comprising an inner core 11 comprising a central axial hole 111; a plurality of permanent magnets 2; a plastic body 3; and a plurality of outer iron cores 12. A plurality of radial grooves 121 are formed between every two adjacent outer iron cores 12, and the plurality of permanent magnets 2 are correspondingly disposed in the plurality of radial grooves 121, respectively; the inner core 11 comprises a circumferential outer wall comprising a plurality of dovetail grooves 112 spaced apart; each of the plurality of outer iron cores 12 comprises an inner end comprising a dovetail protrusion 122; the plurality of outer iron cores 12 are disposed around the circumferential outer wall of the inner core 11, and dovetail protrusions 122 are embedded in the plurality of dovetail grooves 112, respectively; a gap 100 is formed between a front end 122a of each of the dovetail protrusions 122 and a bottom end 112a of each of the plurality of dovetail grooves 112; the plastic body 3 integrates the inner core 11, the plurality of outer iron cores 12, and the plurality of permanent magnets 2 into a whole body, and a part of the plastic body 3 is embedded in the gap 100. The dovetail grooves and dovetail protrusions are matched to fix the inner and outer iron cores, avoiding the relative position movement between the inner and outer iron cores due to the size changes of injection molding material in high temperature and humidity environments. The injection pressure ensures the bonding force between the inner and outer iron cores, ensuring the outer diameter size of the rotor, and effectively preventing noise and edge rubbing of the motor rotor.

The inner core 11 is a single non-magnetic nonferrous metal block, which is easy to produce and can prevent magnetic leakage.

The material for the inner core 11 is aluminum alloy, or austenitic stainless steel, or copper material.

The distance between the front end 122a of each of the dovetail protrusions 122 and the bottom end 112a of each of the plurality of dovetail grooves 112 is L1; the distance between an outer circumferential wall of the plastic body 3 and an outer circumferential wall of the plurality of outer iron cores 12 is L2; and L1≥2.5×L2. The design ensures that the gap 100 between the front end 122a of each of the dovetail protrusions 122 and the bottom end 112a of each of the plurality of dovetail grooves 112 is filled with injection molding material. At the same time, the injection pressure pushes the outer iron core to better fit with the mold, ensuring the roundness of the rotor and effectively preventing noise and edge rubbing of the motor rotor.

The distance between the outer circumferential wall of the plurality of outer iron cores 12 and a center 01 of the central axial hole 111 is C, and C=r×cos(10°−15°), where r represents a radius of the rotor. The design can reduce the torque pulsation and suppress the noise.

The axial length D1 of the plurality of permanent magnets 2 is larger than the axial length D2 of the plurality of outer iron cores 12. The design can fully utilize the rotor performance and improves the overall efficiency of the motor.

The dovetail protrusion 122 comprises a neck connected to the front end, and the neck is narrower than the front end; and the plurality of dovetail grooves 112 comprises a narrow opening and a wide inside, and the dovetail protrusion is embedded in the dovetail groove via the narrow opening.

Each of the plurality of outer iron cores 12 comprises a through hole 123; during injection molding, a part of the plastic body 3 is embedded in the through hole 123.

Each of the plurality of outer iron cores 12 further comprises a location hole 124 for easy positioning and guidance on the mold, and the structural arrangement is reasonable.

The disclosure further provides a motor, comprising a rotation shaft, the abovementioned rotor, a stator assembly, and a housing.

It will be obvious to those skilled in the art that changes and modifications may be made, and therefore, the aim in the appended claims is to cover all such changes and modifications.

What is claimed is:

1. A rotor, comprising:
an inner core comprising a central axial hole;
a plurality of permanent magnets;
a plastic body; and
a plurality of outer iron cores;
wherein:
a plurality of radial grooves are formed between every two adjacent outer iron cores, and the plurality of permanent magnets are correspondingly disposed in the plurality of radial grooves, respectively;
the inner core comprises a circumferential outer wall comprising a plurality of dovetail grooves spaced apart;
each of the plurality of outer iron cores comprises an inner end comprising a dovetail protrusion;
the plurality of outer iron cores are disposed around the circumferential outer wall of the inner core, and dovetail protrusions of the plurality of outer iron cores are embedded in the plurality of dovetail grooves, respectively;
a gap is formed between a front end of each of the dovetail protrusions and a bottom end of each of the plurality of dovetail grooves; and
the plastic body integrates the inner core, the plurality of outer iron cores, and the plurality of permanent magnets into a whole body, and a part of the plastic body is embedded in the gap.

2. The rotor of claim 1, wherein the inner core is a single non-magnetic nonferrous metal block.

3. The rotor of claim 2, wherein a material for the inner core is aluminum alloy, or austenitic stainless steel, or copper material.

4. The rotor of claim 1, wherein a distance between the front end of each of the dovetail protrusions and the bottom end of each of the plurality of dovetail grooves is L1; a distance between an outer circumferential wall of the plastic body and an outer circumferential wall of the plurality of outer iron cores is L2; and L1≥2.5×L2.

5. The rotor of claim 4, wherein a distance between the outer circumferential wall of the plurality of outer iron cores and a center of the central axial hole is C, and C=r×cos(10°−15°), wherein r represents a radius of the rotor.

6. The rotor of claim 5, wherein an axial length D1 of the plurality of permanent magnets is larger than an axial length D2 of the plurality of outer iron cores.

7. The rotor of claim 6, wherein the dovetail protrusion comprises a neck connected to the front end, and the neck is narrower than the front end; and the plurality of dovetail grooves comprises a narrow opening and a wide inside, and the dovetail protrusion is embedded in the dovetail groove via the narrow opening.

8. The rotor of claim 7, wherein each of the plurality of outer iron cores comprises a through hole; during injection molding, a part of the plastic body is embedded in the through hole.

9. The rotor of claim 8, wherein each of the plurality of outer iron cores further comprises a location hole.

10. A motor, comprising a rotation shaft, a rotor of claim 1, a stator assembly, and a housing.
